(19) United States
(12) Patent Application Publication
(10) Pub. No.: US 2026/0201690 A1
(43) Pub. Date: Jul. 16, 2026

(54) DATA COLLECTION AND PROCESSING SYSTEMS

(71) Applicant: British Telecommunications Public Limited Company, London Greater London (GB)

(72) Inventors: Ian THURLOW, London Greater London (GB); Alistair DUKE, London Greater London (GB); Ryan SHIMMON, London Greater London (GB); Richard WISEMAN, London Greater London (GB); Stephen MCCONNELL, London Greater London (GB); Nicholas DAVIES, London Greater London (GB); Evandro PIOLI MORO, London Greater London (GB)

(21) Appl. No.: 19/136,183

(22) PCT Filed: Dec. 5, 2023
(86) PCT No.: PCT/EP2023/084278

§ 371 Date: Jun. 5, 2025

(30) Foreign Application Priority Data
Dec. 9, 2022 (EP) 22212528.8

(51) Int. Cl. E03F 7/00; G01F 23/292; G01S 17/08; G05D 1/689; G05D 105/80; G05D 109/25; G06V 20/17; G06V 20/56

(52) U.S. Cl. CPC E03F 7/00; G01F 23/292; G01S 17/08; G05D 1/689; G06V 20/17; G06V 20/56; G05D 2105/89; G05D 2109/254

(57) ABSTRACT

The present invention provides a system comprising: a memory; and one or more processors configured to: receive a plurality of distance measurements obtained by one or more sensors at different positions in the vicinity of a drain; identify one or more first subsets of the distance measurements as being indicative of the distance between the sensors and the ground surrounding the drain and identify one or more second subsets of the distance measurements as being indicative of the distance between the sensors and water in the drain; and determine, based on the identified first subsets of the measurements and the identified second subsets of the measurements, an estimate of the distance between the water in the drain and the ground surrounding the drain. The present invention also provides a corresponding method.

### FIELD

The present invention relates to systems for collecting and processing data.

### BACKGROUND

A wide range of sensors are deployed in smart cities and Internet of Things (IoT) projects worldwide, including sensors for monitoring air quality, relative humidity, wind speed, and road surface temperature, to name but a few. It is common practice to mount sensors on local authority assets such as streetlamp columns, with the data generated by those sensors forwarded to and assembled in an IoT data hub or data exchange for subsequent analysis and processing.

Many local authorities are exploring the use of sensors to monitor water and silt levels in roadside drainage inlets (or gullies), and to use that data to inform and change cleaning and maintenance schedules. Rather than work to a fixed cleaning schedule, maintenance/cleaning operations can be altered dynamically to focus these operations on locations where they are needed most.

Despite the benefits that can be gained through the deployment of roadside sensor technology, the cost of installing and maintaining thousands of sensors across a wide geographic area is likely prohibit their widespread adoption, so much so that only a small number of sensors are expected to be deployed at key locations. A sensor could for example, be fitted in the lowest lying gully of a set of interconnected gullies, where the outlet from that gully empties into the rainfall drainage network or soak away. Sensors could also be fitted to gullies where blockages are known to have caused significant disruption in the past. Alternatively, a sensor fitted in one gully could act as a proxy for other gullies in the immediate geographic area.

### SUMMARY

A vehicle (e.g. an autonomous vehicle such as a UAV) is herein described which can visit the sites of roadside drainage gullies and capture data which can be used to provide estimates of levels of water and/or silt in the gully and, where relevant (e.g. following recent rainfall), estimates of water flowing from the gully. The vehicle may be equipped with one or more of: cameras, on-board sensor/measurement systems, an infra-red laser range finder (LRF), a global positioning system (GPS) receiver, on-board computer and peripheral devices, machine learning libraries, and communications technology.

Moving the vehicle around in relation to the gully will produce a range of distance readings from the sensors. Some of these readings will be indicative of the distance between the sensors and the ground level, but some readings will be indicative of the distance between the sensors and the water/silt in the gully (e.g. measured through the gaps in the gully grating). Taking the differences between these two sets of readings gives an estimate of the level of water/silt in the gully. Based on this estimated level, a state of the gully (e.g. blocked, partially blocked, unblocked) can be determined. These processing steps may be carried out by processors on the vehicle itself, or by processors in a processing system remote from the vehicle.

Images captured by the on-board cameras can be stored and processed either locally or remotely to determine the position of the vehicle with respect to the gully. This information can be used to position the vehicle in a position in relation to the gully which allows appropriate measurements to be taken.

A vehicle including the measurement systems described herein will make the collection of water, silt, and water flow data from roadside gullies a practical and cost-effective proposition compared to manual inspection or data driven approaches where data is collected from sensors installed in a limited number of roadside gullies.

According to an aspect, there is provided a system comprising: a memory; and one or more processors configured to: receive a plurality of distance measurements obtained by one or more sensors at different positions in the vicinity of a drain; identify one or more first subsets of the distance measurements as being indicative of the distance between the sensors and the ground surrounding the drain and identify one or more second subsets of the distance measurements as being indicative of the distance between the sensors and water (optionally, and silt) in the drain; and determine, based on the identified first subsets of the measurements and the identified second subsets of the measurements, an estimate of the distance between the water (optionally, and silt) in the drain and the ground surrounding the drain.

The one or more processors may be further configured to determine, based on the estimate of the distance, a state of the drain.

The memory may be configured to store data defining the depth of the drain. The one or more processors may be configured to: determine, based on the depth of the drain and the estimate of the distance between the water (optionally, and silt) in the drain and the ground surrounding the drain, an estimate of how full the drain is; and determine, based on the estimate of how full the drain is, the state of the drain.

The state of the drain may be one of the following: blocked, partially blocked or unblocked.

The one or more processors may be further configured to receive one or more images of the drain.

The one or more processors may be configured to: determine, based on the images and/or the distance measurements, that the drain is at least partially covered by debris; and generate an indication that the drain is at least partially covered by debris.

The one or more processors may be configured to: determine, based on the images, that the drain is covered by a drain cover including a plurality of openings; determine a pattern associated with the openings (optionally, an arrangement, an orientation and/or a number, etc.) of the drain cover; and compare the pattern against the number of identified first subsets and/or the number of identified second subsets. Optionally, said comparison is performed so as to reconcile the pattern with the number of the subsets. Optionally, the second subsets comprise an equal number of measurements as there are openings in the drain cover.

According to another aspect, there is provided a system comprising: a memory; and one or more processors configured to: receive one or more images of a drain; and determine, based on the one or more images of the drain, a movement pattern for a vehicle in the vicinity of the drain to permit the vehicle to survey the drain.

The one or more processors may be configured to, in response to determining, based on the images of the drain, that the drain is covered by a drain cover including a plurality of openings: determine a pattern associated with the openings of the drain cover; and generate a (first) movement pattern for the vehicle based on the pattern associated with the openings of the drain cover.

The one or more processors may be configured to, in response to determining, based on the images of the drain, that the drain is uncovered: generate a (second) movement pattern for the vehicle such that, when following the movement pattern, the vehicle passes over the drain and at least a part of the area surrounding the drain and/or generate an indication that the drain is uncovered.

The memory, the one or more processors and the sensors of any of the above aspects may be implemented in a, or the, vehicle or a processing system remote from said vehicle.

The system of any of the above aspects may include a vehicle including the sensors, and a processing system remote from the vehicle. The processing system may include the memory and the one or more processors.

The vehicle may be an aerial vehicle or a ground vehicle; and/or an autonomous or a manned vehicle.

The sensors may comprise an ultrasonic sensor configured to use different frequencies of sound so as to determine a type of surface being surveyed.

According to another aspect of the invention there is provided a method is provided for determining the state of a drain, the method being performed by one or more processors, and the method comprising the steps of: receiving a plurality of distance measurements obtained by one or more sensors at different positions in the vicinity of a drain; identifying one or more first subsets of the distance measurements as being indicative of the distance between the sensors and the ground surrounding the drain and identifying one or more second subsets of the distance measurements as being indicative of the distance between the sensors and water in the drain; and determining, based on the identified first subsets of the measurements and the identified second subsets of the measurements, an estimate of the distance between the water in the drain and the ground surrounding the drain.

According to yet another aspect of the invention there is provided a computer-readable medium comprising computer program code configured to, when loaded on and executed by a computer, causes the computer to carry out the method described above.

### BRIEF DESCRIPTION OF THE FIGURES

Aspects of the present disclosure will now be described by way of example with reference to the accompanying figures. In the figures:

FIG. 1 shows a block diagram of a vehicle according to an embodiment;

FIG. 2 shows a block diagram of a processing system according to an embodiment;

FIG. 3 shows a block diagram of a system including a vehicle and a processing system according to an embodiment;

FIGS. 4A and 4B show a schematic diagram of a UAV taking distance measurements; and

FIG. 5 shows a graph of exemplary distance measurements taken by a sensor.

### DETAILED DESCRIPTION OF EMBODIMENTS OF THE INVENTION

Embodiments of the present invention utilise a vehicle (e.g. an autonomous vehicle such as a UAV) to visit the sites of roadside drainage gullies, and collect and store data related to the state of the gully. The data related to the state of the gully may be processed on board the vehicle, or may be forwarded to a separate processing system, such as a centralised IoT data hub, for storage, further processing, and querying by other systems. The processing system can use machine learning algorithms to process the data received from the autonomous vehicle in order to identify gullies in immediate need of cleaning and/or maintenance. The processing system may also apply suitable machine-learning algorithms on the data collected from the gullies, combined with other data, to identify gullies that may need cleaning and/or maintenance in the short-term. The other data may include: historic and/or forecasted precipitation data; historic and/or forecasted wind speed data; and data on the classification of the road.

Data collected by the vehicle may include: photographic images of the drainage gully; raw data collected from the on-board sensors or cameras; transformed data such as classifications concerning the status of the gully (e.g. blocked, partially blocked, clear); the estimated depth of water and silt in the gully; and, where there has been recent rainfall, an estimate or classification of water flowing out of the gully (e.g. flow/no flow).

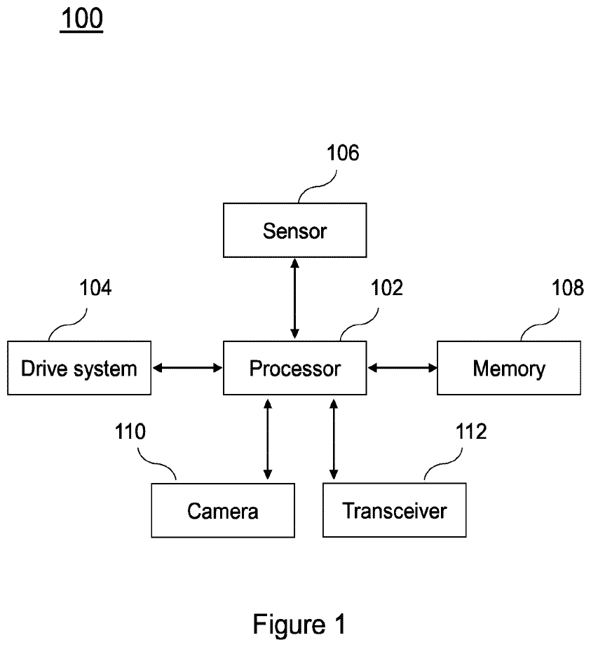

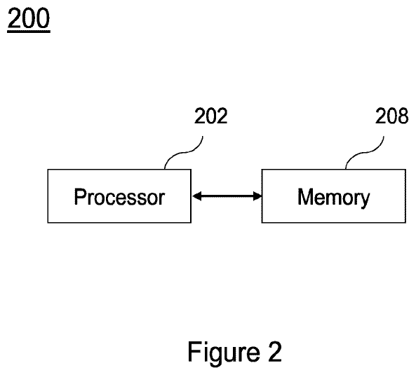

FIG. 1 is a block diagram showing a vehicle according to an embodiment. In the present embodiment, the vehicle is a UAV 100. The UAV 100 includes a processor 102, a drive system 104, a sensor 106, a memory 108, a camera 110 and a transceiver 112. The UAV 100 is in communication with a separate processing system 200, as shown in FIG. 2. The UAV 100 can communicate with the processing system 200 via the transceiver 112.

The processor 102 controls the overall operation of the UAV 100. Although a single processor 102 is shown in FIG. 1, multiple processors may be used in other examples. The processor 102 can control the drive system 104 to move the UAV 100 in a desired direction, or in a flight pattern. The processor 102 can also control the drive system 104 to maintain the UAV 100 at a particular position. The processor 102 may determine the absolute position of the UAV 100 using data obtained from a GPS receiver (not shown).

The sensor 106 is configured to perform distance measurements, such as measurements of the distance between the sensor 106 and the ground. In the present example, the sensor 106 is a time-of-flight (ToF) sensor, such as a laser ToF sensor or an ultrasonic ToF sensor.

In some examples, the UAV may include multiple sensors. In cases where multiple sensors are used, the sensors may be of different types and/or disposed at different positions on the UAV. Using multiple sensors (even of the same type) in different positions allows the measurements to be taken more quickly, and if there are multiple types of sensors then one type of sensor may be able to obtain a reading where another type might not. For example, lasers that emit different wavelengths of light may be used, and wavelengths which reflect better off water may be chosen. In another example, different frequencies of sound (e.g. ultrasound) may be used to determine the type of surface being surveyed (e.g. hard or soft), to establish whether debris such as mud or leaves is present. In yet another example, a metal detector may be used to detect the drain cover.

The processor 102 can control the drive system 104 to move the UAV 100 in a flight pattern over a drain or gully. The processor 102 can control the sensor 106 to take distance measurements at different points along the flight pattern. This results in a series of distance measurements. The processor 102 can store the distance measurement data in the memory 108. The processor may also transmit the distance measurement data to the processing system 200 via the transceiver 112.

In some examples, the processor 102 is configured to control the drive system 104 to move the UAV 100 to different heights relative to the ground at different points along the flight pattern. If distance readings are taken from multiple heights, then multiple sets of height differences will be obtained. This may provide more precise/reliable distance measurements. Also, for a partially blocked grating (i.e. a grating with a limited number of gaps in the grating to measure the water/silt levels), it may be beneficial to manoeuvre the UAV 100 to a lower height above the grating to get a sufficient number of measurements (compared to a situation where the gully grating is free from debris).

The processor 102 is configured to sort the distance measurement data into subsets which relate to the same feature, e.g. the grating of the drain. This can be achieved by clustering data points using a clustering algorithm such as k-means.

More specifically, the processor 102 is configured identify first subsets of the distance measurement data as being indicative of the distance between the vehicle and the ground surrounding the drain. For example, if the drain is covered by a drain cover which is at substantially the same level as the ground surrounding the drain, distance measurements from the drain cover can be indicative of the distance between the vehicle and the ground surrounding the drain.

The processor 102 is also configured to identify second subsets of the distance measurement data as being indicative of the distance between the vehicle and water/silt in the drain. In cases where the drain is covered by a drain cover, these distance measurements may be obtained through openings (e.g. slits or holes) in the drain cover.

The processor 102 may also identify third subsets of the distance measurement data as being indicative of the distance between the vehicle and objects which are sitting on a drain cover of the drain and/or objects which are lodged in the drain between the drain cover and the water/silt in the drain. Typically, there should be two main groups/clusters of readings, one corresponding to the drain cover/road level and one corresponding to the water/silt level. If there is one or more additional cluster, then this could indicate an object in the drain but above the water/silt (if the average distance of the cluster is between the road/cover level and the water/silt level) or sitting on/near the drain cover (if the average distance of the cluster is closer to the vehicle than the road/cover). The processor 102 may determine that clusters are not as separated or clearly defined as expected and then control the sensor 106 to perform a further series of measurements at a higher measurement density and/or use an alternative sensor (or the camera 110) to capture further data to attempt to identify the issue.

The processor 102 can compare the first subsets of the measurements and the second subsets of the measurements to obtain an estimate of the distance between the water/silt in the drain and the ground surrounding the drain. For example, the processor 102 can take an average (e.g. the mean or the median) of the data of the first subsets to give an estimate of the average distance to the ground (or drain cover), and can take an average (e.g. the mean or the median) of the data of the second subsets to give an estimate of the average distance to the water/silt. The processor 102 can take the difference between these two average distances to obtain an estimate of the distance from the water/silt to the top of the drain. The processor 102 can store the estimate of the distance in memory 108. In some examples, the processor 102 may transmit the estimate of the distance to the processing system 200 via the transceiver 112.

Based on the distance between the water/silt and the top of the drain, the processor 102 can determine a state of the drain. The processor 102 may determine a state of the drain using machine learning libraries stored in the memory 108. Generally speaking, the smaller the distance between the water/silt and the top of the drain, the more water is present in the drain and the more likely it is that the drain is blocked. In an example, the processor 102 may determine that a drain is blocked if the distance is less than 20 cm, or may determine that a drain is partially blocked if the distance is between 20 cm and 50 cm. The processor 102 may determine that a drain is clear (i.e. not blocked) if the distance is more than 50 cm.

In some examples, the processor 102 can access data defining the depth of the drain. This data may be stored in the memory 108 or may be obtained from the processing system 200. Based on this data, the processor 102 can determine how full the drain is (e.g. as a percentage). For example, if the drain is 1 m deep and the distance between the water/silt and the top of the drain is determined as 10 cm, then the processor 102 can determine that the drain is 90% full and is likely to be blocked. If the drain is 50% to 80% full, the processor 102 can determine that the drain is partially blocked, and if the drain is less than 50% full, the processor 102 can determine that the drain is clear. A combination of percentage values and absolute values may also be used to determine the state of the drain.

In some examples, the processor 102 can access data defining the height of the outlet pipe of the drain. A drain that has water up to the level of the outlet pipe could be considered to be in a state of ‘normal’ operation (i.e. an unblocked state). This ‘offset’ may be taken into account in the classification of the drain.

The processor 102 may store data defining the determined state of the drain in the memory 108. In some examples, the processor 102 can transmit the data defining the state of the drain to the processing system 200 via the transceiver 112, for further processing.

In the present example, the processor 102 can use the camera 110 to capture one or more images of the drain and/or the surrounding area. The processor 102 can use the captured images to identify the approximate location of the drain and can control the drive system 104 to move the UAV 100 to the identified location. In some cases, the drain/drain cover may be at least partially covered by debris, such as leaves or soil. In such cases, the processor 102 may determine the presence of the debris by analysing the captured images. The processor 102 can transmit information regarding the presence of the debris to the processing system 200. The processing system 200 can use this information to flag that the drain needs cleaning.

The processor 102 may analyse the captured images and determine that the drain is covered by a drain cover. In such cases, the processor 102 can further analyse the images showing the drain cover to determine a pattern of the openings (e.g. slits or holes) in the drain cover, and can determine an appropriate flight pattern based on this analysis. The analysis may involve determining the orientation of the openings in the drain cover. For example, if the drain cover includes a series of regularly spaced rectangular slits, the processor 102 may set a flight pattern which leads the UAV 100 to fly over the drain cover in a direction perpendicular to the long axes of the slits, thereby allowing the sensor 106 to take measurements through multiple slits. This improves the reliability of the determination of the level of the water/silt in the drain, since it should result in a relatively even distribution of distance measurement values in the two main subsets, rather than having lots of readings in one subset and very few readings in the other subset.

The processor 102 may also use the determined pattern of the openings in the drain cover as part of the process of identifying subsets of the distance measurements. For example, if the drain cover has three slits, then there should be at least three subsets of data which are indicative of the distance between the vehicle and water/silt in the drain. The processor 102 may cross-reference the data regarding the pattern of the openings with the processed distance measurement data to verify that the identification process has been performed correctly. This increases the accuracy of the identification process.

In some cases, the processor 102 may analyse the images of the drain and determine that no drain cover is present. In such cases, the processor 102 may set a flight pattern which covers a broad area including the drain, to ensure that the sensor 106 can take distance measurements of the road surrounding the drain to compare with the distance measurements of the drain itself. The processor 102 may also transmit information indicating the absence of a drain cover to the processing system 200, so that the relevant authorities may be notified of the presence of a potential safety hazard.

In the present example, the memory 108 stores a default flight pattern for the UAV 100, such as a “zig-zag” flight pattern or a spiral flight pattern. In the absence of any information regarding the presence or absence of a drain cover, the processor 102 can control the drive system 104 to move the UAV 100 in the default flight pattern in the vicinity of the drain, so that the sensor 106 can take the distance measurements. This arrangement allows the UAV 100 to carry out the distance measurements even if the camera 110 is not present or not operational.

In some examples, the UAV 100 includes one or more microphones (not shown) which can detect acoustic energy resulting from water flowing from a drain. In such cases, the UAV 100 may also include an analogue-to-digital converter (ADC) which can convert analogue signals from the microphones into a digital format for processing by the processor 102. The processor 102 can process the digital signals to determine an estimate of the amount of water flowing from the drain.

The memory 108 may store data relating to the layout of a drainage system including the drain. In such cases, the processor 102 may, based on the data relating to the layout of the drainage system, identify another drain in the drain system that is connected to the drain. The other drain may be, for example, a drain neighbouring the current drain. The processor 102 can then control the drive system 104 to move the UAV 100 to other drain, so that the UAV 100 can take measurements to determine the state of the other drain.

FIG. 2 shows a block diagram of a processing system. In the present example, the processing system 200 is an IoT data hub. The processing system 200 includes a processor 202 and a memory 208. The processor 202 may be configured to carry out any of the processing operations performed by the processor 102 of the vehicle 100 described in relation to FIG. 1.

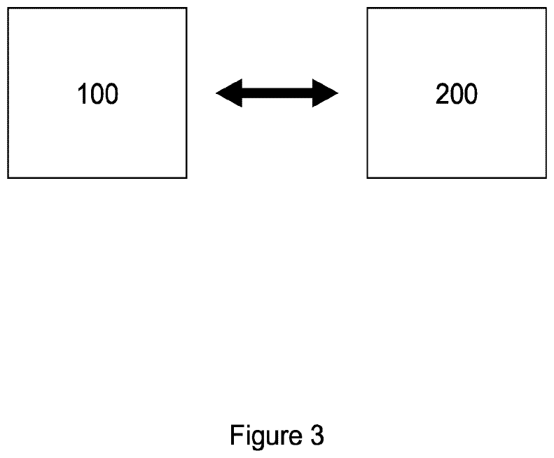

FIG. 3 shows a block diagram of a system according to an embodiment. The system includes the vehicle 100 as described above in relation to FIG. 1 and the processing system 200 as described above in relation to FIG. 2. The vehicle 100 and the processing system 200 can communicate with each other over a wireless telecommunications network, e.g. a wireless telecommunications network which operates in accordance with 4G or 5G technology.

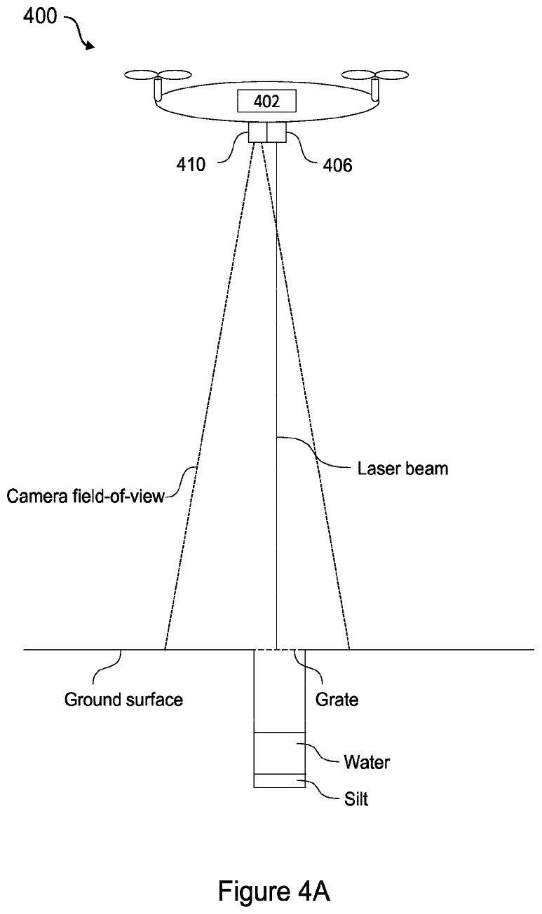

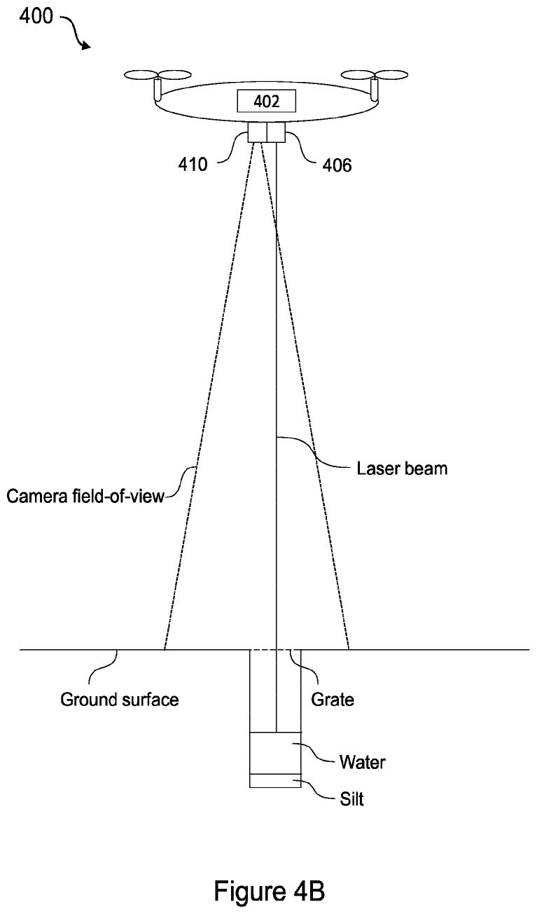

FIGS. 4A and 4B show a UAV 400 positioned above a drain with a grate. The UAV 400 may be similar to the UAV 100 described above in relation to FIG. 1. The UAV 400 is equipped with a downward pointing camera 410 and a ToF sensor 406. The ToF sensor 406 includes a downward pointing laser configured to emit a laser beam, and a corresponding detector. Data collected from the ToF sensor 406 and the camera 410 can be processed by processor 402 to determine the position of the grate.

Moving the UAV 400 around above the drain will produce a range of distance readings from the ToF sensor 406, some from the grate and the ground surrounding the drain, as well as some taken through the gaps in the grate. In FIG. 4A, the UAV 400 is positioned so that the laser beam emitted by the laser is incident on the drain grate. When the position of the UAV 400 is changed slightly, the laser beam can be pointed through one of the gaps, as shown in FIG. 4B. This allows the distance to the water/silt in the drain to be measured. If the sensor 406 and camera 410 are calibrated appropriately, it is possible to calculate for which point in the camera image the sensor 406 is measuring the distance from the UAV 400 to the water/silt. For example, the position of the laser beam in the image will be dependent upon the height of the UAV 400, and this could be calibrated/measured in a configuration stage. If the laser emits light which is visible to the camera 410, then the light incident on the surface of the drain cover would be visible in the camera image. The light incident on the surface of the drain cover may therefore be detected and its position on the cover determined in that way.

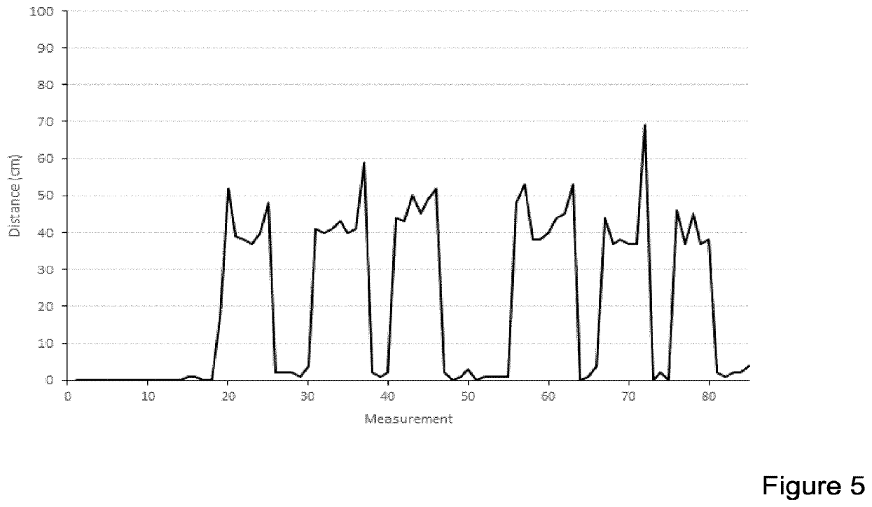

FIG. 5 shows an example of distance measurements taken by a sensor moving over a drain covered by a cover. In this example, the cover has three slots. The sensor was moved over the cover twice in opposite directions. As shown in the graph, there are six relatively large subsets of data which can be divided into two groups corresponding to the respective scan directions.

In this example, the average height of the sensor above the grating was estimated to be 1.8 cm. The average distance to the water in the drain was estimated from the six relatively large subsets as 43.2 cm. Hence, the distance between the water and the top of the drain was estimated to be 41.4 cm.

In the embodiments described above, the vehicles are aerial vehicles. In other embodiments, the vehicle may be a ground vehicle (e.g. an autonomous ground vehicle) which includes one or more sensors configured to perform distance measurements. Such a vehicle may drive along a gutter and over a drain in order to position the sensor over the drain to take distance measurements. Alternatively, the vehicle may drive beside the road (e.g. on a pavement) and project a sensor assembly including the sensor out over a drain to take distance measurements.

The ground vehicle may include a sweeper device arranged to clear debris, and a processor of the vehicle may be configured to control the sweeper device to clear debris from a drain prior to controlling the sensor to perform the distance measurements. This may improve the quality of the obtained distance measurements.

Whilst certain embodiments have been described, these embodiments have been presented by way of example only and are not intended to limit the scope of the application. Various further modifications to the above-described embodiments, whether by way of addition, deletion, or substitution, will be apparent to the skilled person to provide additional embodiments, any and all of which are intended to be encompassed by the appended claims.

1. A system comprising:
a memory; and
one or more processors configured to:
receive a plurality of distance measurements obtained by one or more sensors at different positions in the vicinity of a drain;
identify one or more first subsets of the distance measurements as being indicative of the distance between the sensors and the ground surrounding the drain and identify one or more second subsets of the distance measurements as being indicative of the distance between the sensors and water/silt in the drain; and
determine, based on the identified first subsets of the measurements and the identified second subsets of the measurements, an estimate of the distance between the water/silt in the drain and the ground surrounding the drain.

2. A system according to claim 1, wherein the one or more processors are configured to determine, based on the estimate of the distance, a state of the drain.

3. A system according to claim 2, wherein the memory is configured to store data defining the depth of the drain, and
wherein the one or more processors are configured to:
determine, based on the depth of the drain and the estimate of the distance between the water/silt in the drain and the ground surrounding the drain, an estimate of how full the drain is; and
determine, based on the estimate of how full the drain is, the state of the drain.

4. A system according to claim 2, wherein the state of the drain is one of the following: blocked, partially blocked or unblocked.

5. A system according to claim 1, wherein the one or more processors are further configured to receive one or more images of the drain.

6. A system according to claim 5, wherein the one or more processors are configured to:
determine, based on the images and/or the distance measurements, that the drain is at least partially covered by debris; and
generate an indication that the drain is at least partially covered by debris.

7. A system according to claim wherein the one or more processors are configured to:
determine, based on the images, that the drain is covered by a drain cover including a plurality of openings;
determine a pattern associated with the openings of the drain cover; and
compare the pattern against the number of identified first subsets and/or the number of identified second subsets.

8. A system comprising:
a memory; and
one or more processors configured to:
receive one more images of a drain; and
determine, based on the one or more images of the drain, a movement pattern for a vehicle in the vicinity of the drain to permit the vehicle to survey the drain.

9. A system according to claim 8, wherein the one or more processors are configured to, in response to determining, based on the images of the drain, that the drain is covered by a drain cover including a plurality of openings:
determine a pattern associated with the openings of the drain cover; and
generate a first movement pattern for the vehicle based on the pattern associated with the openings of the drain cover.

10. A system according to claim wherein the one or more processors are configured to, in response to determining, based on the images of the drain, that the drain is uncovered:
generate a second movement pattern for the vehicle such that, when following the movement pattern, the vehicle passes over the drain and at least a part of the area surrounding the drain, and/or
generate an indication that the drain is uncovered.

11. A system according to claim 1, wherein the memory, the one or more processors and the sensors are implemented in a vehicle.

12. A system according to claim 1, comprising:
a vehicle including the sensors; and
a processing system remote from the vehicle, wherein the processing system comprises the memory and the one or more processors.

13. A system according to claim 11, wherein the vehicle is an aerial vehicle.

14. A system according to claim 11, wherein the vehicle is a ground vehicle.

15. A system according to claim 11, wherein the vehicle is an autonomous vehicle.
